(19) United States
(12) Patent Application Publication
(10) Pub. No.: US 2016/0055708 A1
(43) Pub. Date: Feb. 25, 2016

(54) Wagering aid

(71) Applicant: Gaming Studio, Inc., Fargo, ND (US)

(72) Inventors: Joseph Richardson, Fargo, ND (US); Ryan Hatfield, Fargo, ND (US)

(21) Appl. No.: 14/830,627

(22) Filed: Aug. 19, 2015

Related U.S. Application Data
(60) Provisional application No. 62/039,130, filed on Aug. 19, 2014.

(51) Int. Cl. G07F 17/32; G06K 19/06

(52) U.S. Cl. CPC G07F 17/3223; G07F 17/3209; G06K 19/06037; G06K 19/06112

(57) ABSTRACT

Methods and system for facilitating the in-person wagering process. A bettor operates a device, such as a smartphone or tablet PC, to indicate the various indicia of a desired wager: amount, event, etc. In some embodiments, the device facilitates the indication by presenting past wagers or other preconstructed wagers. Once the wager or wagers are finalized, the device displays a graphical indicia permitting access to the various attributes of the wager(s). The graphical indicia may also include other desirable features such as error correction, authentication, etc.

### CROSS-REFERENCE TO RELATED APPLICATIONS

The present application claims the benefit of co-pending U.S. provisional application No. 62/039,130, filed on Aug. 19, 2014, the entire disclosure of which is incorporated by reference as if set forth in its entirety herein.

### TECHNICAL FIELD

The invention relates generally to methods and systems for facilitating the placement of wagers, and more specifically to the use of graphical indicia in a variety of forms to place and store wagers.

### BACKGROUND

Wagering typically involves a bettor and a gaming establishment as represented by its agent (e.g., croupier, dealer, wheel operator, gaming clerk, cashier, etc.). Wagers have been placed using virtually every form of communication technology imaginable: telephone calls, telegrams, websites, video conferencing, etc.

A significant portion of the gaming market, however, still relies on in-person wagering for the placement of bets. In-person wagering still faces all of the issues associated with oral contract formation: mistakes in communication, fraud, verification, payout, etc.

Accordingly, there is a need for methods and systems that can help facilitate accuracy in the in-person wagering process.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Embodiments of the present invention concern methods and system for facilitating the in-person wagering process. A bettor operates a device, such as a smartphone or tablet PC, to indicate the various indicia of desired wager: amount, event, etc. In some embodiments, the device facilitates the indication by presenting past wagers or other preconstructed wagers. Once the wager or wagers are finalized, the device displays a graphical indicia permitting access the various attributes of the wager(s). The graphical indicia may also include other desirable features such as error correction, authentication, etc.

The graphical indicia can be scanned by the gaming establishment or his agent using, e.g., a camera or dedicated scanning device. The image of the graphical indicia can then be decoded to yield the terms of the wager(s) selected by the bettor. The terms may be verified using information encoded in the indicia before being accepted by the gaming establishment.

In one aspect, embodiments of the present invention relate to an apparatus for planning wagers for a wheel-based gaming system. The apparatus includes a user interface and a processor. The user interface accepts user input and provides output to a user. The processor is communicatively coupled to the user interface and configured to execute instructions from a storage to provide a display to the user for wager selection using the user interface, receive a wager selection based on user input via the user interface, and display a scannable indicia of the wager selection using the user interface.

In one embodiment, the indicia is a QR code. In one embodiment, the indicia indicates one or more of at least one wager selection, the value of the at least one wager selection, and at least one wager event to which the at least one wager selection and the value applies. In one embodiment, the indicia includes a reference to a data record that includes information about the wager selection.

In one embodiment, the apparatus further comprises a wireless communication interface communicatively coupled to the processor for communicating with a wager acceptance device. In one embodiment, the storage includes one or more stored wager selections. In one embodiment, the wager selected via the user interface is a stored wager selection. In one embodiment, the one or more stored wager selections are sorted according to a parameter.

In one embodiment, the wager selection includes at least two selections of individual randomly determined elements. In one embodiment, the set of items includes one or more of an individual wheel ring segment, a combination of wheel ring segments, or a group of wheel ring segments with a predetermined characteristic.

In another aspect, embodiments of the present invention relate to an apparatus for processing wagers for a wheel-based gaming system. The apparatus includes a display, an interface, and a processor. The display displays wager selections made in the wheel-based gaming system. The interface receives a wager selection. The processor is communicatively coupled to the display and to the interface and is configured to execute instructions from a storage to receive an indicia of a wager selection via the interface, display the wager selection on the display, and display a simulation of an operating gaming wheel on the display.

In one embodiment, the apparatus further includes an optical scanner communicatively coupled to the processor and configured to scan an indicia to obtain the wager selection. In one embodiment, the processor is further configured to identify wager selections with winning wagers based on an outcome of the operating gaming wheel; the processor may be further configured to calculate payouts based on an identified wager selection and the indicia.

In one embodiment, the interface further includes a user interface configured to accept user input and display a wager selection determined by the user input. In one embodiment, the interface further comprises a communication interface configured to receive wager selections via a communication link.

In one embodiment, the processor is further configured to determine that a source of the wager selection received via the interface is located on a pre-defined premises that is shared by the wheel-based gaming system. In one embodiment, the processor is further configured to cause the display to display one or more of a number of players or a number of valid wager selections made for a next event for the wheel-based gaming system.

In another aspect, embodiments of the present invention relate to a method of planning wagers for a wheel-based gaming system. The method includes receiving a wager selection via an interface, displaying the wager selection on a display, displaying a simulation of an operating gaming wheel on the display, and identifying wager selections with winning wagers based on an outcome of the operating gaming wheel.

In yet another aspect, embodiments of the present invention relate to a method of processing wagers for a wheel-based gaming system. The method includes receiving a wager selection via an interface, displaying the wager selection on a display, displaying a simulation of an operating gaming wheel on the display, and identifying wager selections with winning wagers based on an outcome of the operating gaming wheel.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following figures in which:

FIG. 1 is a diagram of one embodiment of a system for planning and processing wagers in accord with the present invention;

FIG. 2 is a block diagram of the user device 100 of FIG. 1;

FIG. 3 is a block diagram of the operator device 104 of FIG. 1;

FIG. 4 is a flowchart of a method for planning wagers in accord with the present invention; and

FIG. 5 is a flowchart of a method for processing wagers in accord with the present invention.

In the drawings, like reference characters generally refer to corresponding parts throughout the different views. The drawings are not necessarily to scale, emphasis instead being placed on the principles and concepts of operation.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are the means used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions that could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The processes and displays presented herein are not inherently related to any particular computer or other apparatus. Various general purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

Traditional wager placement is a spoken or handwritten process, subject to miscommunication, sloppy handwriting, paper defects, data entry errors, etc. Embodiments of the present invention facilitate the placement of wagers in connection with various games of chance (e.g., Keno, Tri-Wheel, etc.). A user operates a device to specify the parameters associated with a desired wager. The device generates an indicia, such as a scannable code, associated with or encoding the parameters specified by the user. An operator scans the indicia to retrieve the specified parameters and accept the wager, thereby avoiding transcription errors, data entry errors, etc.

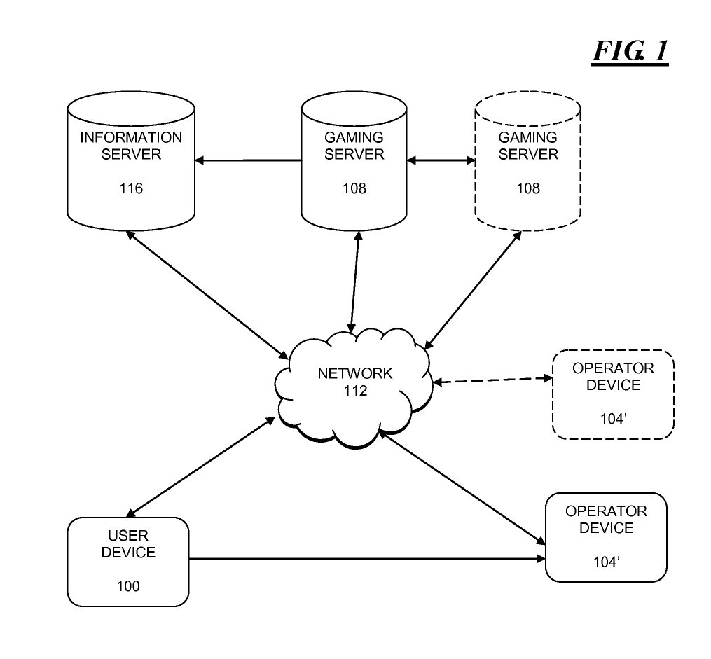

FIG. 1 presents one embodiment of a system facilitating wager placement in accord with the present invention. The system includes a user device 100, an operator device 104, and one or more gaming servers 108. The system is typically deployed in a gaming establishment of some kind, such as a casino, a bar or restaurant offering gaming tables, a keno parlor, etc.

While all of these elements are typically in contact at least indirectly through network 112, it is often the case that the user device 100 and the operator device 104 are not in direct communication with each other besides the use of indicia containing bet selections and parameters, as discussed in greater detail herein. This is typically done for security reasons, i.e., to prevent illicit access to the operator device 104, regulatory reasons, e.g., legal requirements specifying how wagering devices are to be operated, or political reasons, e.g., ensuring that bets are being made on licensed premises and not electronically transmitted from unlicensed or unapproved locations (such as private residences).

The user device 100 may take a variety of forms, including but not limited to a smartphone, a tablet computer, a phablet, a laptop computer, a dedicated wagering device, etc. In most embodiments the user device 100 is portable, so that a user may formulate or monitor a wager from any location, but be physically present on a licensed premises to make a wager or collect a prize.

Similarly, the operator device 104 may take the form of a dedicated point-of-sale (POS) device, a desktop computer, a thin client device, a device running a web browser interacting with a gaming server 108, each in connection with a printer and scanner, etc. The form and the capabilities of the operator device 104 may be prescribed for regulatory or other reasons.

The gaming server 108 is typically located outside the same premises as the user device 100 and/or the operator device 104. It may take the form of a dedicated server, a server farm, a virtual server, a desktop computer, etc. Again, the form and the capabilities of the gaming server may be prescribed for regulatory or other reasons.

Network 112 is a depiction of the umbrella of communications technologies that may permit any combination of the user device 100, the operator device 104, and the gaming server(s) 108 to communicate. As is apparent to one of ordinary skill, network 112 is composed from a variety of links, with each link bridging one or more devices using a variety of technologies.

For example, when the user device 100 is a smartphone, the network 112 includes the 802.11x-based transceivers, the Bluetooth-based transceivers, and the wireless network transceivers (e.g., GSM, CDMA, LTE, etc.) included in the smartphone and used by the smartphone for communications. Similarly, when the operator device 104 is a dedicated POS device, network 112 includes the 802.11x-based transceivers and the wireline transceivers (e.g., Ethernet, FDDI, etc.) included in the POS device and used by the POS device for communications. This is also true of gaming server 108, although one would expect the connection with the gaming server(s) 108 to be high-capacity (to handle communications with many user devices 100 and operator devices 104), wireline (to prevent eavesdropping and other security threats), and redundant (to reduce the likelihood that a single point of failure) will disable the gaming network.

Some embodiments will utilize an information server 116. The information server allows the gaming establishment to provide information to a user device 100 without allowing the user device 100 to have access to a gaming server 108, which may constitute a security risk or a violation of applicable law or regulation. A one way connection from a gaming server 108 to an information server 116 permits the gaming server 108 to post information concerning wagers, payouts, etc. to the information server 116. A user device 100 may subsequently access the information server 116 to obtain that information for display, wager formulation, reporting, etc.

In operation, a user wanting to place a wager will interact with his or her user device 100. User device 100 will present an interface of some kind to the user, and the user's manipulation of that interface enables the user to formulate one or more wagers that can be placed with a gaming establishment.

For example, the user device 100 may present the user with a list of options that the user may select in order to formulate a wager. The options will vary depending on the type of game at issue. For example, when the game is a multi-ring wheel type game, the options may include the number of units wagered, the number of spins bet, and the particular spaces or combinations of spaces that might otherwise appear on a tablet layout. The betting options may vary when, e.g., the game is Keno or some other ticket-based game.

In another embodiment, the user device 100 may present the user with a historical list of wagers that the user may select in order to formulate a wager. The user may manipulate the list of historical wagers by filtering or sorting the list according to, e.g., date, wager unit value, wager unit size, price per spin, a “nickname” associated with the wager, etc.

Once the user is satisfied with his or her specified wager(s), the user device 100 generates a computer-friendly indicia that encodes the relevant parameters of the wagers. In one embodiment, the indicia is in a format that is similar to a wagering receipt including the details of the wagers placed. In another embodiment, the indicia is a bar code (e.g., QR code, DataMatrix, PDF417, etc.) or another graphical indicator that is amenable to automated processing.

In some embodiments the indicia may also encode parameters that facilitate other operations that are useful in the wager placement context, such as error correction, financial transactions (e.g., credit card numbers, bank accounts, PayPal information, Google Wallet information, etc.), user identification (e.g., name, driver's license, etc.)., etc.

In another embodiment, the indicia does not directly encode the relevant parameters, but instead includes a reference to a data record that contains the relevant parameters. For example, the reference may be a Uniform Resource Locator (URL) pointing to a data record on the Internet containing the relevant parameters, an index to a data record contained in an accessible database, etc.

Once the indicia is generated, it needs to be communicated from the user device 100 to the operator device 104. While the user device 100 may be indirectly in communication with the operator device 104, e.g., in that each of the devices may exchange information via gaming servers 108, they typically (depending on gaming jurisdiction) are not in direct communication with each other via, e.g., a TCP/IP connection over a wireless network link.

Accordingly, various embodiments of the invention provide the indicia in such a way that it may be received by the operator device 104 without requiring a direct network linkage. For example, in one embodiment the user device 100 displays the indicia on a screen (LCD, LED, E-Ink, etc.) and the operator device 104 includes a scanner (e.g., a camera, a barcode scanner, etc.) that is configured to read such indicia. In another embodiment the user device 100 prints a paper ticket including the indicia and the operator device 104 includes a scanner that is configured to read such a ticket. In yet another embodiment the user device 100 plays an audible or inaudible sequence of sounds encoding the indicia that can be received by a microphone or other sound input at the operator device 104. In still another embodiment the user device 100 operates a visible or non-visible light LED to transmit the indicia using pulses of light.

Once the operator device 104 has received the generated indicia through manual input, scanning, or the like, the operator device decodes the indicia to obtain the relevant parameters for the user's desired wagers. The decoding may include or be accompanied by various related steps, such as an automated confirmation step that involves various error correcting information contained in the indicia, a manual confirmation step that involves the display of the decoded indicia by the operator device 104 to the user for confirmation of the desired wager, the access of a remote data source containing various wager parameters using access information encoded in the indicia, etc.

Once the desired wagers have been received at the operator device 104, they may be placed in accord with conventional wagering methods. Such methods may include, e.g., the transmission of the received wager to a gaming server 108, the issuance of a printed or electronic record evidencing the acceptance of the wager by the gaming clerk, the display of various winning and losing wagers, the payout of winning wagers, the collection of funds associated with an accepted wager, etc.

Embodiments of the system that utilize an information server 116 may permit the user to personally confirm that their wagers have been accepted, that their wager has been processe, that their wagers have won and the amount of the payout; to utilize past wagers as the basis for constructing future wagers, etc.

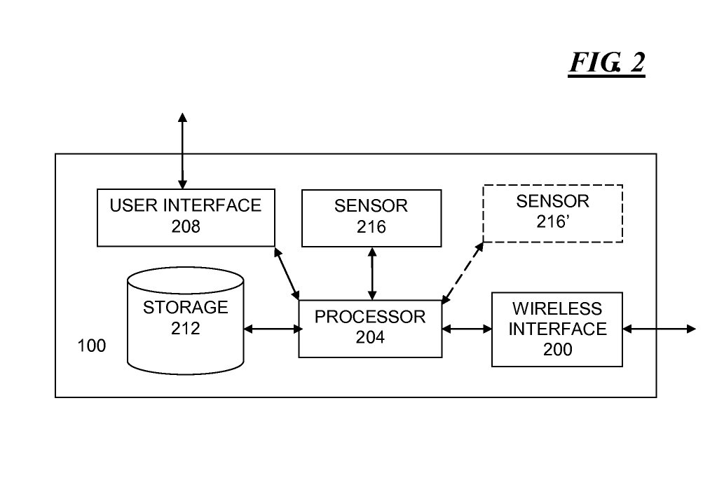

FIG. 2 describes an exemplary user device 100 in additional detail. The user device 100 may be a dedicated tablet containing wagering software in ROM or a persistent memory and one or more of the components depicted in FIG. 2 or a general purpose device such as an IPHONE or other smartphone device running an application that facilitates wagering activities as discussed herein.

The wireless interface 200 allows the user device 100 to transmit communications to other devices and, in one embodiment, provides an interface to network 112. Suitable network interfaces 200 include gigabit Ethernet, Wi-Fi (802.11a/b/g/n), Bluetooth, and 3G/4G wireless interfaces such as GSM/WCDMA/LTE that enable data transmissions between user device 100 and other devices such as the gaming server 108.

A processor 204 processes data relating to wager placement, generates communications for transmission through the interface 200, and processes communications received through the interface 200 that originate outside the user device 100. A typical processor 204 is an x86, x86-64, or ARMv7 processor, and the like.

The user interface 208 allows the user device 100 to receive commands from and/or provide feedback to the user; one particular form of feedback involves the presentation of interactive graphic elements on a touch-sensitive screen (LCD, LED, etc.). Other exemplary user interfaces include graphical displays, physical keyboards, virtual keyboards, etc.

Storage 212 provides both transient and persistent storage for data conveyed via the interface 200, data processed by the processor 204, data received or sent via the user interface 208 and other forms of data handled by the user device 100.

The user device 100 in various embodiments typically includes one or more sensors 216 that provide various forms of data that may be processed by the processor 204, presented to the user by interface 208, stored in storage 212, etc. For example, a user device 100 may include a positioning sensor 216 (e.g., GPS, GLONASS, Galileo, etc.) that may permit the identification of the location of the user device 100. Such information may prove useful in connection with the processing of wagers, as discussed below. Other sensors 216 in the user device 100 may include a camera, an accelerometer, etc.

The user device 100 may take a variety of forms. It may appear in a variety of attractive colors, and may be configured to be waterproof, shockproof, and easy to keep track of The user device 100 may be powered by replaceable batteries, such as alkaline batteries, or it may include its own batteries that are rechargeable using, e.g., a micro-USB/mini-USB/Firewire port, etc.

As discussed above, the user device 100 is operated by a user to formulate wagers for placement in connection with various casino games, including but not limited to Keno, multi-ring wheel games, etc. The user interacts with a user interface to select or specify various parameters related to the desired wagers, either de novo or utilizing previously-placed wagers, wager templates, etc. Once the desired wagers are finalized, the user device 100 generates a graphical indicia for use in communicating those wagers to the operator device 104.

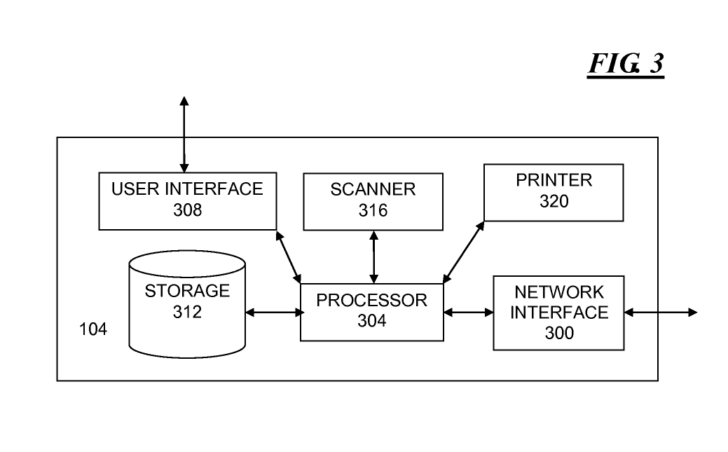

FIG. 3 describes the operator device 104 in additional detail. As discussed above, the operator device 104 can take various forms, physical and virtual, but most implementations will share certain common functionalities.

The network interface 300 allows the operator device 104 to receive communications from other devices and, in one embodiment, provides a bidirectional interface to network 112. Suitable network interfaces 300 include gigabit Ethernet, Wi-Fi (802.11a/b/g/n), and 3G/4G wireless interfaces such as GSM/WCDMA/LTE that enable data transmissions between operator device 104 and other devices such as gaming server(s) 108.

A processor 304 processes data related to scanned indicia, generates communications for transmission through the interface 300, and processes communications received through the interface 300 that originate outside the operator device 104. A typical processor 304 is an x86, x86-64, or ARMv7 processor, and the like.

The user interface 308 allows the analytics device 104 to receive commands from and/or provide feedback to an operator. Exemplary user interfaces include graphical displays, physical keyboards, virtual keyboards, etc.

Storage 312 provides both transient and persistent storage for data conveyed via the interface 300, data processed by the processor 304, data received or sent via the user interface 308, and other forms of data handled by the operator device 104.

Scanner 316 may take a variety of forms as it operates to scan presented indicia to obtain parameters related to wagers to be placed. If the indicia is graphical, the scanner 316 may be a camera or a dedicated barcode scanner. If the indicia is sound-based (audible or inaudible), then the scanner 316 may be a microphone. If the indicia is a data signal conveyed by near-field communications (NFC) such as Bluetooth, then the scanner 316 may be an NFC (e.g., Bluetooth) transceiver.

Printer 320 may be used to print tickets for wagerers confirming the details of an accepted wager. It may also be used by an operator to print various reports of interest (e.g., daily profit and loss statements, per-user betting records, etc.).

As discussed above, an operator operates the operator device 104 to scan a presented indicia generated by a user device 100. The indicia is parsed (e.g., decoded) to yield the parameters associated with one or more wagers that a user desires to place. This process avoids the errors and other issues associated with verbal wager placement, wager placement using hand-marked forms, etc. Once the parameters have been extracted, they may be presented to the user for confirmation or other purposes. The parameters may subsequently be transmitted to one or more gaming servers 108 for resolution and the subsequent determination of winning and losing wagers.

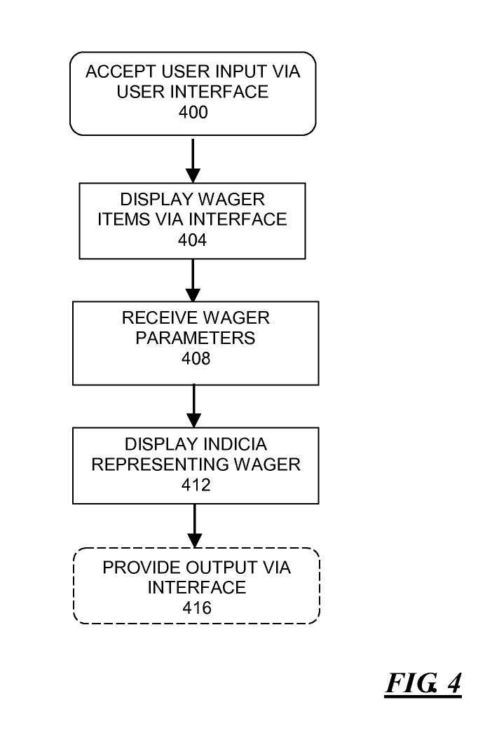

FIG. 4 is a flowchart of a method for planning wagers in accord with the present invention. As discussed above, such a method may be performed by a user operating a user device, although no such limitation is inherent to the method itself and it may be performed using a variety of other inventive and prior art apparatuses.

The method begins when the user interacts with a device via a user interface, supplying one or more forms of input (Step 400). The input may take a variety of forms, including the execution of a selected application, the entry of a URL associated with a wagering application, etc. Once the wagering application is executed, then the user input may include the specification of various filtering criteria to control the display of historically-placed wagers or wager templates, etc.

The user input prompts the display of wager items via a user interface (Step 404). If the user input includes an indication that the user wants to place an entirely new bet, the wager items may include various fields that allow for the specification of various wager parameters, including but not limited to wager amounts, number of wagers, unit size, amount to be wagered, wager event, etc. If the user input includes an indication that the user wants to place a bet using a wager template, then the displayed wager items may include various predetermined values that a user may accept in their entirety or modify, in part or in whole, before placing the wager. If the user input includes an indication that the user wants to place a bet using a previously placed bet, then the displayed wager items may include various previously placed bets; additional user input may be used to specify criteria to sort or filter the previously placed bets that are displayed (by date, by wager amount, by winning status, etc.).

Regardless of whether the user is presented with an interface that allows for the specification of various wager parameters, an adjustable wager template, or one or more previously placed wagers, the user manipulates the displayed wager items to specify the parameters associated with the wager(s) that the user desires to place. The user device receives the wager parameters specified by the user using the presented interface (Step 408).

Having received the relevant wager parameters from the user, an indicia representing those parameters is generated and displayed (Step 412). In some embodiments, the indicia only contains the relevant wager parameters. In other embodiments, the indicia contains additional information germane to the wager such as, but not limited to, the wagerer's identity, financial account information, etc. The indicia may take a variety of forms in accord with the present invention, including but not limited to visual representations (e.g., barcodes, steganographic images, visible lights, invisible lights, etc.), aural representations (e.g., audible tones, inaudible tones, or a combination of the two), NFC representations (e.g., Bluetooth/NFC communications, etc.).

The user device may, in some embodiments, provide additional output to the user via the user interface (Step 416). The additional output may include, e.g., instructions telling the user to present the displayed indicia to an operator for scanning, to hold the user device in proximity to the operator device for scanning, etc. The additional output may also include a display of the wager parameters encoded in the indicia, e.g., for confirmation purposes.

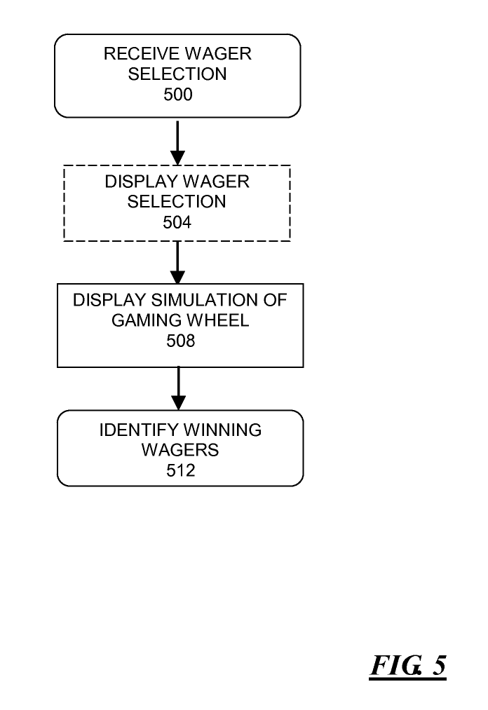

FIG. 5 is a flowchart of a method for processing wagers in accord with the present invention. As discussed above, the wager is processed after it is received by the operator device from the user device (Step 500). This may involve scanning a displayed graphical indicia, receiving an aural indicia via a microphone, receiving an NFC indicia via a Bluetooth transceiver, etc. It may also involve decoding the received indicia, confirming the received indicia with the wagerer, etc. This may also involve the issuance of a printed or electronic receipt (a.k.a. “a ticket”) to the wagerer that may be used later to pay out winning wagers as discussed below.

In a typical installation, the operator device is in proximity to at least one screen that presents a simulated version of a physical gambling device. For example, instead of a physical

TRI-WHEEL and betting board, a screen may display a computer-generated TRI-WHEEL with another optional screen displaying the betting layout. The same is true for other casino games such as roulette, Keno, etc.

In such an arrangement, the received wagers may be displayed on a screen in a manner that would be analogous to the placement of a wager in connection with a physical table layout (Step 504). For example, when the display includes the optional computer-generated betting layout, each received wager may be displayed as virtual chips placed in the appropriate location on virtual layout.

When the betting round for a particular game has closed a simulation of a gaming event may be presented on the display (Step 508). For example, when the simulated game is a TRI-WHEEL game, the simulated gaming event may involve the spin of the wheel. If the simulated game is Keno, the simulated gaming event may involve the display of numbers, and/or the display of an event generating those numbers.

The processing of the wagers will also involve the identification of winning and losing wagers (Step 512), as well as the payout of winning wagers. The wagerer may present a printed or electronic ticket (e.g., a PDF file) as proof of their winning wager and receive a payout from the operator. In embodiments where the indicia includes financial transaction information, then the payout may occur automatically without require the wagerer to present a printed or electronic ticket.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

What is claimed is:

1. An apparatus for planning wagers for a wheel-based gaming system, the apparatus comprising:
a user interface for accepting user input and providing output to a user;
a processor communicatively coupled to the user interface and configured to execute instructions from a storage to:
provide a display to the user for wager selection using the user interface;
receive a wager selection based on user input via the user interface; and
display a scannable indicia of the wager selection using the user interface.

2. The apparatus of claim 1 wherein the indicia is a QR code.

3. The apparatus of claim 1 wherein the indicia indicates one or more of at least one wager selection, the value of the at least one wager selection; and at least one wager event to which the at least one wager selection and the value applies.

4. The apparatus of claim 1 wherein the indicia includes a reference to a data record that includes information about the wager selection.

5. The apparatus of claim 1, further comprising a wireless communication interface communicatively coupled to the processor for communicating with a wager acceptance device.

6. The apparatus of claim 1, wherein the storage includes one or more stored wager selections.

7. The apparatus of claim 6, wherein the wager selected via the user interface is a stored wager selection.

8. The apparatus of claim 6, wherein the one or more stored wager selections are sorted according to a parameter.

9. The apparatus of claim 1, wherein the wager selection comprises at least two selections of individual randomly determined elements.

10. The apparatus of claim 9, wherein the set of items includes one or more of an individual wheel ring segment, a combination of wheel ring segments or a group of wheel ring segments with a predetermined characteristic.

11. An apparatus for processing wagers for a wheel-based gaming system, the apparatus comprising:
a display for displaying wager selections made in the wheel-based gaming system;
an interface for receiving a wager selection;
a processor communicatively coupled to the display and to the interface and configured to execute instructions from a storage to:
receive an indicia of a wager selection via the interface;
display the wager selection on the display; and
display a simulation of an operating gaming wheel on the display.

12. The apparatus of claim 11, further comprising an optical scanner communicatively coupled to the processor and configured to scan an indicia to obtain the wager selection.

13. The apparatus of claim 11, wherein the processor is further configured to identify wager selections with winning wagers based on an outcome of the operating gaming wheel.

14. The apparatus of claim 13, wherein the processor is further configured to calculate payouts based on an identified wager selection and the indicia.

15. The apparatus of claim 11, wherein the interface further comprises a user interface configured to accept user input and display a wager selection determined by the user input.

16. The apparatus of claim 11, wherein the interface further comprises a communication interface configured to receive wager selections via a communication link.

17. The apparatus of claim 11, wherein the processor is further configured to determine that a source of the wager selection received via the interface is located on a pre-defined premises that is shared by the wheel-based gaming system.

18. The apparatus of claim 11, wherein the processor is further configured to cause the display to display one or more of a number of players or a number of valid wager selections made for a next event for the wheel-based gaming system.

19. A method for planning wagers for a wheel-based gaming system, the method comprising:
accepting user input and providing output to a user via a user interface;
displaying a set of items via the user interface, the items in the set being manipulated to configure a wager selection;
receiving the wager selection based on user input; and
displaying an indicia representing the wager selection using the user interface.

20. A method for processing wagers for a wheel-based gaming system, the method comprising:
receiving a wager selection via an interface;
displaying the wager selection on a display;
displaying a simulation of an operating gaming wheel on the display; and
identifying wager selections with winning wagers based on an outcome of the operating gaming wheel.
